(19) United States
(12) Patent Application Publication
(10) Pub. No.: US 2010/0225942 A1
(43) Pub. Date: Sep. 9, 2010

(54) COLOR CONVERSION APPARATUS, RECORDING MEDIUM STORING COMPUTER PROGRAM PRODUCT, AND COLOR CONVERSION METHOD

(76) Inventors: Hironobu MURAI, Hokkaido (JP); Hiroaki SAGAE, Hokkaido (JP); Masakazu YOSHIDA, Kanagawa (JP); Takashi KIMURA, Kanagawa (JP); Masanori HIRANO, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/718,591

(22) Filed: Mar. 5, 2010

(30) Foreign Application Priority Data
Mar. 5, 2009 (JP) 2009-052299
Nov. 20, 2009 (JP) 2009-265496

(51) Int. Cl. H04N 1/60

(52) U.S. Cl. 358/1.9

(57) ABSTRACT

A color conversion apparatus, for converting input image data into output image data that is to be output from a recording apparatus using a color material of five colors or more, the color conversion apparatus, includes a color conversion table that is used in performing color conversion of the input image data directly into the output image data; and a color conversion unit that, by making use of the color conversion table, performs color conversion of the input image data directly into the output image data.

### CROSS-REFERENCE TO RELATED APPLICATIONS

The present application claims priority to and incorporates by reference the entire contents of Japanese Patent Application No. 2009-052299 filed in Japan on Mar. 5, 2009 and Japanese Patent Application No. 2009-265496 filed in Japan on Nov. 20, 2009. The present application incorporates by reference the entire contents of Japanese Application No. 2008-237202 filed in Japan on Sep. 16, 2008.

### BACKGROUND OF THE INVENTION

1. Field of the Invention

The present invention relates to a color conversion apparatus, a recording medium storing computer program product, and a color conversion method, and particularly relates to a color conversion apparatus, a recording medium storing computer program product, and a color conversion method for performing color conversion of input image data into output image data that is to be output from a recording apparatus using a color material of five colors or more.

2. Description of the Related Art

The inkjet recording techniques have been drawing attention as suitable recording techniques for office use. That is because, firstly, inkjet recording can be performed at a high speed. Secondly, inkjet recording can be performed on a sheet of plain paper without having to perform any specific image fixing process. Thirdly, the noise generated during inkjet recording is sufficiently small to be ignored. A variety of inkjet recording techniques have been disclosed and some have already been commercialized for actual use. An inkjet recording technique makes use of an inkjet head that includes an ink room and nozzles connected to the ink room. Depending on the image data, certain pressure is applied to the ink filled in the ink room. Consequently, small ink droplets are discharged through the nozzles on a recording target such as paper or a film. The discharged ink droplets get attached to the recording member whereby an image is formed on the recording member. Depending on the configuration of the inkjet head, an inkjet printer can be classified as a serial inkjet printer or a line inkjet printer.

A serial inkjet printer forms an image by moving (main-scanning) the inkjet head across the width direction of the paper sheet. Upon completion of one or more recording passes, the paper sheet is advanced and the subsequent recording line is formed. On the other hand, in a line inkjet printer, the nozzles are arranged over substantially the entire region along the width direction of the paper sheet. In that case, the inkjet head is not moved along the width direction. Rather, an image is formed while advancing the paper sheet beneath the inkjet head. Since a line inkjet printer can form a single recording line in the width direction at once, the recording speed is high. However, because of the nozzle arrangement being over substantially the entire region along the width direction of the paper sheet, the size of the inkjet head increases. That causes an increase in the size of the line inkjet printer. Moreover, to perform high-resolution recording in a line inkjet printer, the nozzles need to be arranged in a precise manner in the inkjet head. That leads to an increase in the manufacturing cost of the inkjet head. In comparison, a serial inkjet printer can form an image with a relatively smaller inkjet head thereby enabling achieving reduction in the manufacturing cost. That is why, at present, a variety of commercialized serial inkjet printers are available in the market.

Typically, in an image output apparatus implementing multi-color inkjet technology, reproduction of a color image is performed with a color mixture of four colors, namely, yellow (Y), magenta (M), cyan (C), and black (K). However, attempts are currently being made to achieve high-quality images by outputting images with colors other than Y, M, C, and K. For example, in the case of using the color mixture of Y, M, C, and K, there are limitations to the color reproduction range. Particularly, in the case of performing color reproduction with high color saturation of secondary colors such as red (R), green (G), and blue (B), the expression with the color mixture of Y, M, C, and K fails to achieve sufficient color saturation thereby resulting in insufficient color reproducibility.

In order to overcome such a problem, Japanese Patent Application Laid-open No. H08-244254 and Japanese Patent Application Laid-open No. H10-44473 disclose a technology of forming an image with the ink of R, G, and B ink apart from the ink of Y, M, C, and K for enhancing color reproducibility of the secondary colors and resolving color running (or, color blurring) due to the color mixture ink of secondary colors.

Moreover, in order to enhance the expressiveness of image gradation and achieve a balance between gradation expression and resolution, a technology has been disclosed in which inks having differing concentrations are used. For example, Japanese Patent Application Laid-open No. 560-19538 discloses a technology of using inks of various differing concentrations and expressing the gradation of an image by the combination of ink dots in a unit pixel (e.g., pixel formed by a 2×2 dot matrix) so that a relatively higher image gradation can be expressed. At the same time, since the number of dots forming a unit pixel does not increase, the image resolution is prevented from decreasing.

As described above, by performing multi-color printing in which an image is output with colors other than Y, M, C, and K; it becomes possible to achieve expansion of the color gamut and enhancement in granularity and gradation. Herein, to enable multi-color printing, it is necessary to implement a color conversion technique that converts the color space of an input image into the color space of an output apparatus. An example of the color conversion technique is disclosed in Japanese Patent Application Laid-open No. 2002-154239.

More particularly, Japanese Patent Application Laid-open No. 2002-154239 discloses a technique of converting the RGB color space of an input image into a CMYKP (P being an arbitrary color) color space as the resultant color space of an output image. In this technique, the RGB color space is first converted into the CMYK color space, which is heretofore known, and the CMYK color space is then converted into the CMYKP color space (see FIG. 7 in Japanese Patent Application Laid-open No. 2002-154239).

However, in that technique, there also occur differences in the amount of generation of halftones, or color plate. The reason for that problem is explained below with reference to FIGS. 17A to 17D. In FIG. 17A, color separation of CMY is performed in the order of K, R, G, and LM; while in FIG. 17C, color separation of CMY is performed in the order of K, G, R, and LM. Even if an identical input value is subjected to color separation in the order illustrated in FIGS. 17A and 17C, then the respective results are obtained as illustrated in FIGS. 17B and 17D. As it is obvious from the comparison of FIGS. 17B and 17D, although the same input value is subjected to color separation, the color output values are different due to the difference in the order of color separation. Consider the case of generating colors in the order of K, R, G, and LM. In that case, K is generated by performing under color removal (UCR) on CMY; R is generated by performing UCR on MY; G is generated by performing UCR on CY; and LM is generated by performing UCR on M. Thus, if color separation is performed in the order of R to G, then CMYK becomes CM′Y′KR (UCR on MY) and CM′Y′KR becomes C′M′Y″KRG (UCR on CY′). In contrast, if color separation is performed in the order of G to R, then CMYK becomes C′MY′KG (UCR on CY) and C′MY′KG becomes C′M′Y″KRG (UCR on MY′). Thus, the difference in the order of color separation also causes difference in the amount of UCR, that is, causes difference in the amount of generation of halftones. The difference in the amount of ink generation leads to the difference in the amount of ink usage that in turn causes aberration in colors. Moreover, there occurs a bias in the consumption/replacement of ink cartridges. Furthermore, since the color separation processing is performed in sequential manner, the amount of calculations increases and the processing speed become delayed, which are problems to be solved in the prior art.

### SUMMARY OF THE INVENTION

It is an object of the present invention to at least partially solve the problems in the conventional technology.

According to an aspect of the present invention, there is provided a color conversion apparatus for converting input image data into output image data that is to be output from a recording apparatus using a color material of five colors or more, the color conversion apparatus including: a color conversion table that is used in performing color conversion of the input image data directly into the output image data; and a color conversion unit that, by making use of the color conversion table, performs color conversion of the input image data directly into the output image data.

According to another aspect of the present invention, there is provided a computer-readable recording medium that stores therein a computer program that causes a computer to implement a color conversion method for converting input image data into output image data that is to be output from a recording apparatus using a color material of five colors or more, the computer program causing the computer to execute: reading a color conversion table that is used in performing color conversion of the input image data directly into the output image data; and performing color conversion of the input image data directly into the output image data by making use of the color conversion table.

According to still another aspect of the present invention, there is provided a color conversion method for converting input image data into output image data that is to be output from a recording apparatus using a color material of five colors or more, the color conversion method including converting the input image data directly into the output image data by making use of a color conversion table that is used to convert the input image data directly into the output image data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an exemplary configuration of an image processing system according to the present embodiment;

FIG. 2 is a schematic diagram of an exemplary functional configuration of an image processing unit;

FIG. 3 is a schematic diagram of an exemplary hardware configuration of a personal computer (PC);

FIG. 4 is a flowchart for explaining the sequence of operations performed by a color conversion unit;

FIG. 5 is a schematic diagram of an exemplary configuration of a color conversion table (for RGB-to-CMYKRGLM conversion);

FIG. 6 is a schematic diagram of an exemplary configuration of a color conversion table for RGB-to-CMYKRGGold conversion;

FIG. 7 is a schematic diagram of an exemplary configuration of a color conversion table for RGB-to-CMYKRGWhite conversion;

FIG. 8 is a schematic diagram of an exemplary configuration of the image processing system in which the image processing unit is disposed in a printer;

FIGS. 9A and 9B are explanatory drawings for explaining the differences in the color conversion processing performed by the color conversion unit according to the present embodiment and the color conversion processing in the conventional technology;

FIG. 10 is a first explanatory diagram for explaining the color conversion table according to the present embodiment;

FIG. 11 is a second explanatory diagram for explaining the color conversion table according to the present embodiment;

FIG. 12 is a schematic perspective view of the mechanical portion of the inkjet recording apparatus;

FIG. 13 is a cross-sectional diagram of the essential portion of an inkjet head in the inkjet recording apparatus illustrated in FIG. 12;

FIG. 14 is an explanatory diagram of nozzles in the inkjet head illustrated in FIG. 12;

FIG. 15 is a block diagram of essential constituent elements of a control unit for the configuration in FIG. 12;

FIGS. 16A to 16E are explanatory diagrams of constituent examples of the color conversion table; and

FIGS. 17A to 17D are explanatory diagrams for explaining the color conversion processing in the conventional technology.

### DETAILED DESCRIPTION OF THE PREFERRED EMBODIMENTS

Exemplary embodiments of the present invention are described in detail below with reference to the accompanying drawings. The present invention is not limited to these exemplary embodiments. Moreover, the constituent elements described in the following embodiments include constituent elements that can easily occur to those skilled in the art or constituent elements that are essentially identical to the described constituent elements.

Given below is the description regarding an image processing system to which are applied a color conversion apparatus, a color conversion method, an image processing system, and a recording medium storing a computer program product according to a first embodiment of the present invention.

### [Image Processing System]

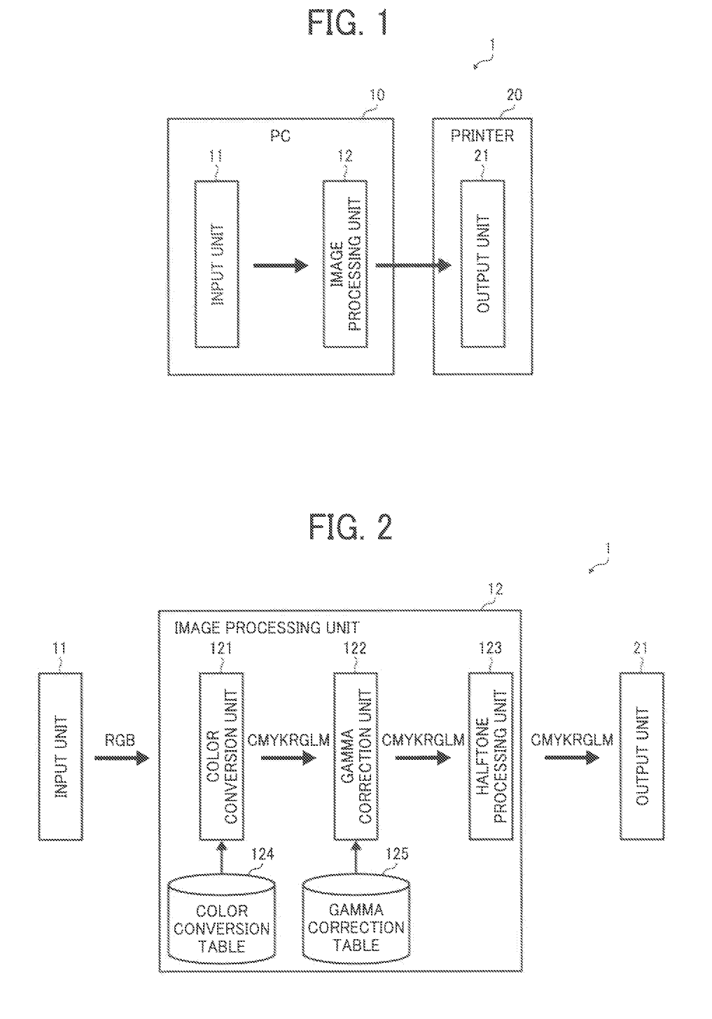

FIG. 1 is a schematic diagram of an exemplary configuration of an image processing system according to the present embodiment. In an image processing system 1 illustrated in FIG. 1, a PC 10 that functions as an information processing apparatus and a printer 20 that functions as a recording apparatus are connected via a network or connected directly to each other via a fixed line (e.g., cable) or in a wireless manner.

The PC 10 includes an input unit 11 and an image processing unit 12. The input unit 11 receives input of image data that is considered by the image processing unit 12 to be the printing target. The image processing unit 12 then performs image processing and converts the input image data into image data that is compatible to the printing operation in the printer 20. The image processing unit 12 is embedded in a software component generally known as the printer driver.

The printer 20 is, for example, an inkjet printer and includes an output unit 21 that receives, from the PC 10, the image data processed by the image processing unit 12 and controls the operation of ensuring that the printer 20 prints the received image data.

FIG. 2 is a schematic diagram of an exemplary functional configuration of the image processing unit 12. As illustrated in FIG. 2, the image processing unit 12 includes a color conversion unit 121 that performs color conversion, a gamma correction unit 122 that performs gamma correction, a halftone processing unit 123 that performs halftone processing, a color conversion table 124 that is a look up table (LUT) used by the color conversion unit 121 for color conversion, and a gamma correction table 125 that is an LUT used by the gamma correction unit 122 for gamma correction.

The color conversion unit 121 converts, with the use of the color conversion table 124, the color space of the input image data (in RGB) directly into CMYK+α (e.g., CMYKRGLM), which are the ink colors, and outputs the image data (in CMYK+α) to the gamma correction unit 122. Then, the gamma correction unit 122 makes use of the gamma correction table 125 and performs gamma correction (density correction) on the image data (in CMYK+α) obtained by the color conversion unit 121. Subsequently, with respect to the gamma-corrected image data (in CMYK+α), the halftone processing unit 123 performs pseudo-halftone processing with the dither error diffusion technique or the like, converts the number of gradations of the image data into the number of gradations (e.g., 2 bit) compatible to the printer 20, and outputs the image data to the output unit 21 in the printer 20.

Meanwhile, the “image data” subjected to color conversion by the color conversion unit 121 is the data per predetermined unit at the time of expressing colors by halftones.

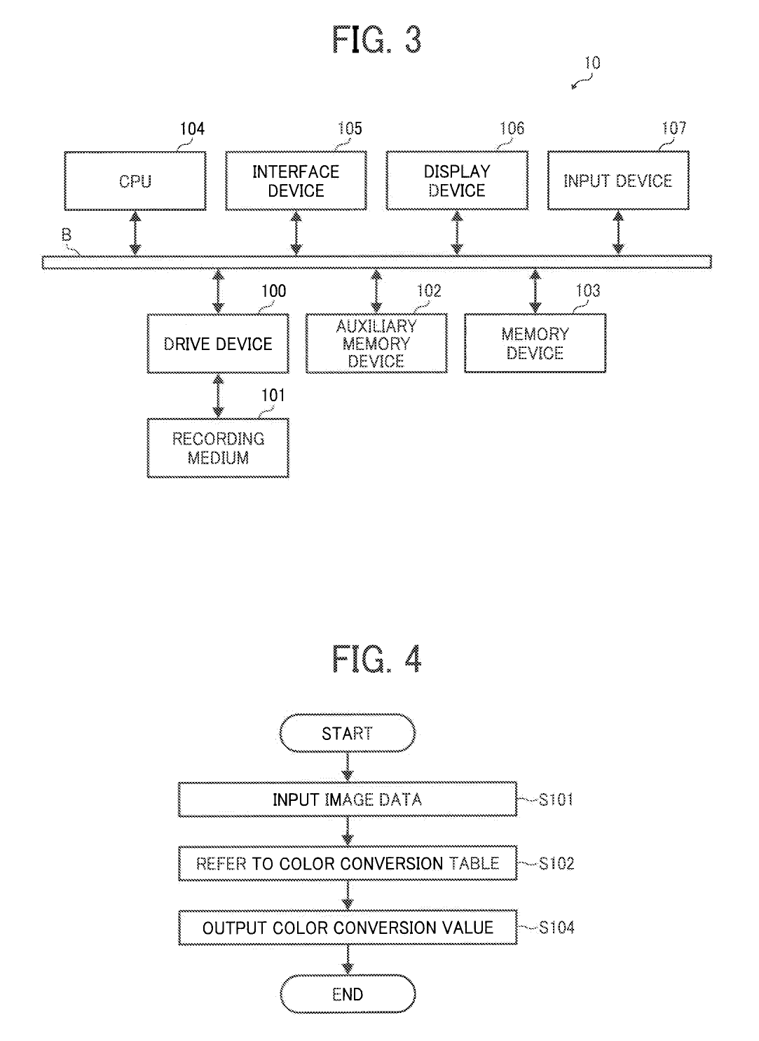

FIG. 3 is a schematic diagram of an exemplary hardware configuration of the PC 10 illustrated in FIG. 1. As illustrated in FIG. 3, the PC 10 includes a drive device 100, an auxiliary memory device 102, a memory device 103, a central processing unit (CPU) 104, an interface device 105, a display device 106, and an input device 107 that are interconnected by a bus B.

The computer programs that are executed to implement operations in the PC 10 are provided in a recording medium 101 such as a compact disk read only memory (CD-ROM). When the recording medium 101 having the computer programs recorded therein is set in the drive device 100, the computer programs get installed in the auxiliary memory device 102 from the recording medium 101 via the drive device 100. In addition to the installed programs, the auxiliary memory device 102 stores therein necessary files or data. For example, the auxiliary memory device 102 stores therein the color conversion table 124 and the gamma correction table 125.

When a computer program execution instruction is issued, the memory device 103 reads the computer programs from the auxiliary memory device 102 and stores therein the computer programs. The CPU 104 follows instructions in the computer programs stored in the memory device 103 and implements the functions of the PC 10. The interface device 105 functions as an interface for network connection. The display device 106 displays thereon a graphical user interface (GUI) created by a computer program. The input device 107 includes a keyboard and a mouse and is used to input various operation instructions. Meanwhile, it is not always necessary to install the computer programs using the recording medium 101. Alternatively, the computer programs can be downloaded from another computer that is disposed over the network.

### [Color Conversion Unit and Color Conversion Table]

Given below is the detailed explanation about the color conversion unit 121 and the color conversion table 124 in the image processing unit 12 illustrated in FIG. 2. FIG. 4 is a flowchart for explaining the sequence of operations performed by the color conversion unit 121 in the image processing unit 12 illustrated in FIG. 2. As illustrated in FIG. 2, first, the input unit 11 outputs the input image data to the color conversion unit 121 (Step S101). Then, the color conversion unit 121 refers to the color conversion table 124 (Step S102), performs color conversion on the input image data, and outputs a conversion value (output value) (Step S104). Meanwhile, the explanation given herein is for the case when RGB data is converted into CMYKRGLM data.

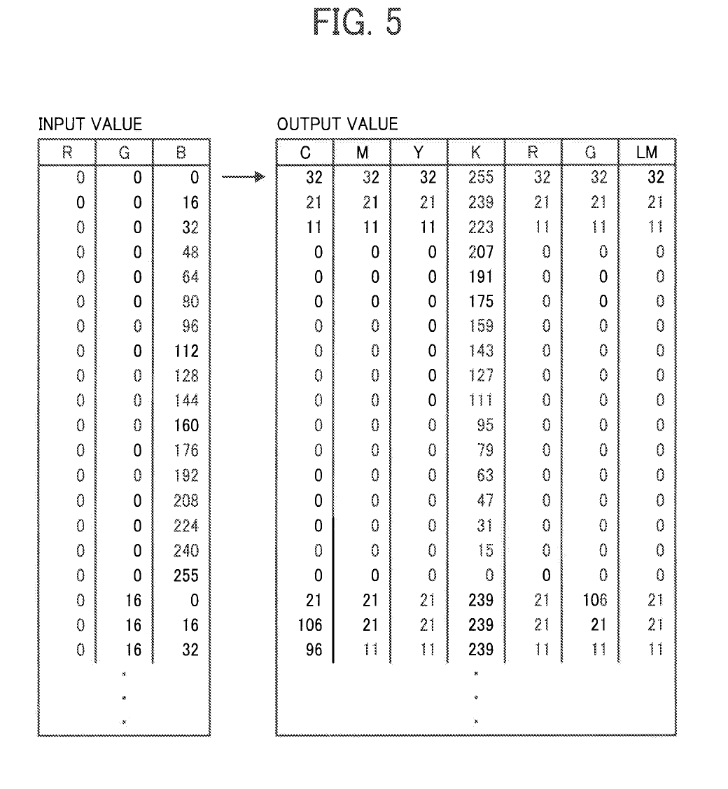

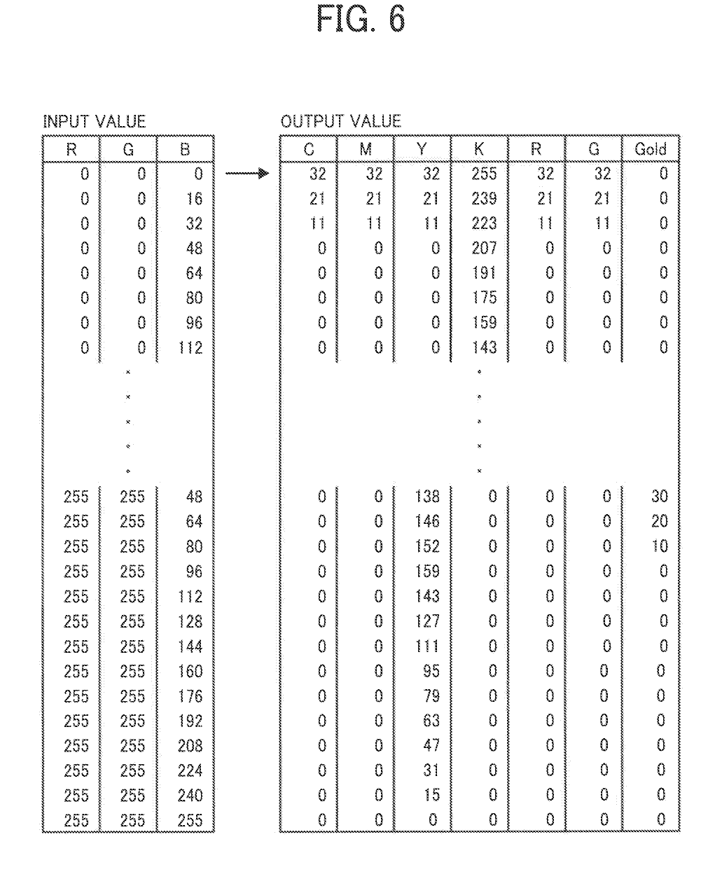

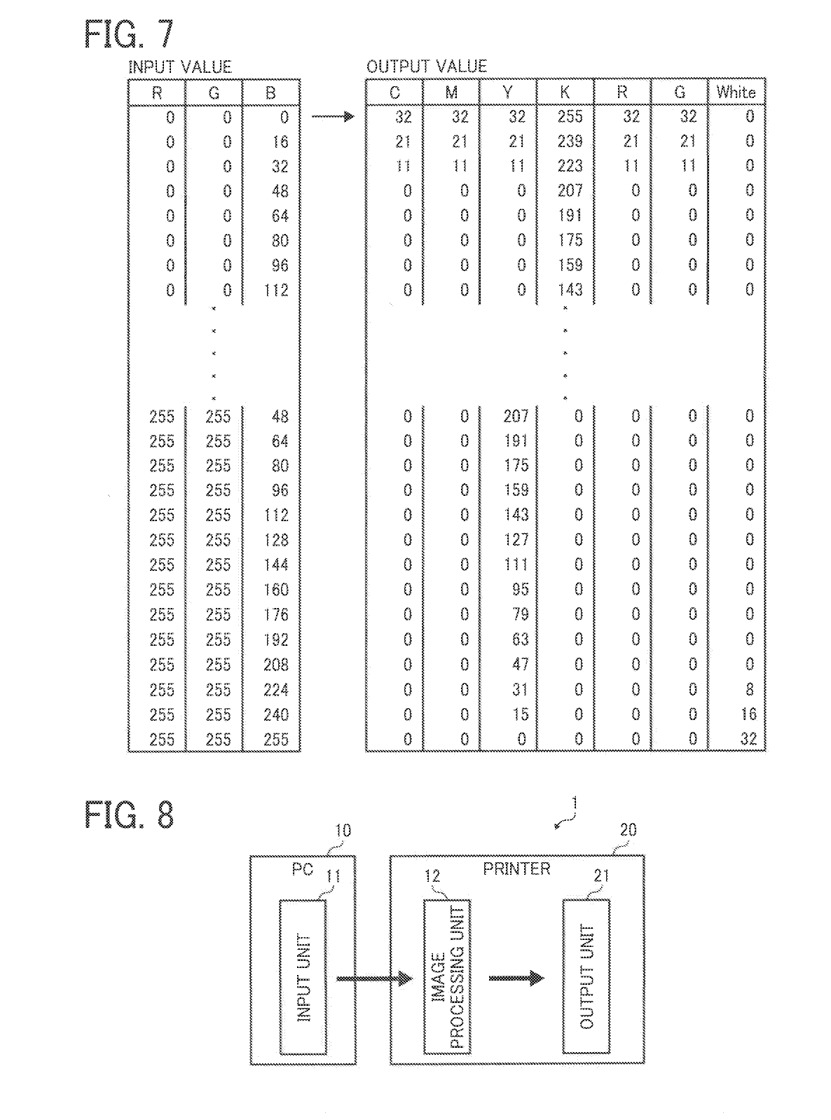

FIG. 5 is a schematic diagram of an exemplary configuration of a color conversion table (for RGB-to-CMYKRGLM conversion). As illustrated in FIG. 5, in the color conversion table 124, RGB values that are the input values (grid points) are stored in a corresponding manner with respect to CMYKRGLM values that are the output values (grid point values). Regarding the output values that correspond to the in-between input values of the grid points, interpolated values are calculated by performing interpolation calculating processing such as cubical interpolation, triangle pole interpolation, or tetrahedral interpolation. Although the explanation with reference to FIG. 5 is given for the case of RGB-to-CMYKRGLM conversion, it is also possible to perform other types of color conversion in an identical manner. For example, FIG. 6 is a schematic diagram of an exemplary configuration of a color conversion table for RGB-to-CMYKRGGold conversion, while FIG. 7 is a schematic diagram of an exemplary configuration of a color conversion table for RGB-to-CMYKRGWhite conversion.

Meanwhile, with the use of the gamma correction table 125, density correction can be performed on the color conversion table 124 so that the operations performed by the gamma correction unit 122 can be omitted. In that case, since color conversion and density correction is performed at the same time, it becomes possible to reduce the processing time.

In the image processing system 1 illustrated in FIG. 1, the image processing unit 12 is assumed to be disposed in the PC 10. Instead, the image processing unit 12 can also be disposed in the printer 20. FIG. 8 is a schematic diagram of an exemplary configuration of the image processing system 1 in which the image processing unit 12 is disposed in the printer 20. As illustrated in FIG. 12, the PC 10 sends pre-color-conversion RGB data to the printer 20 and the image processing unit 12 in the printer 20 then performs image processing of color conversion or the like.

### [Color Conversion Unit]

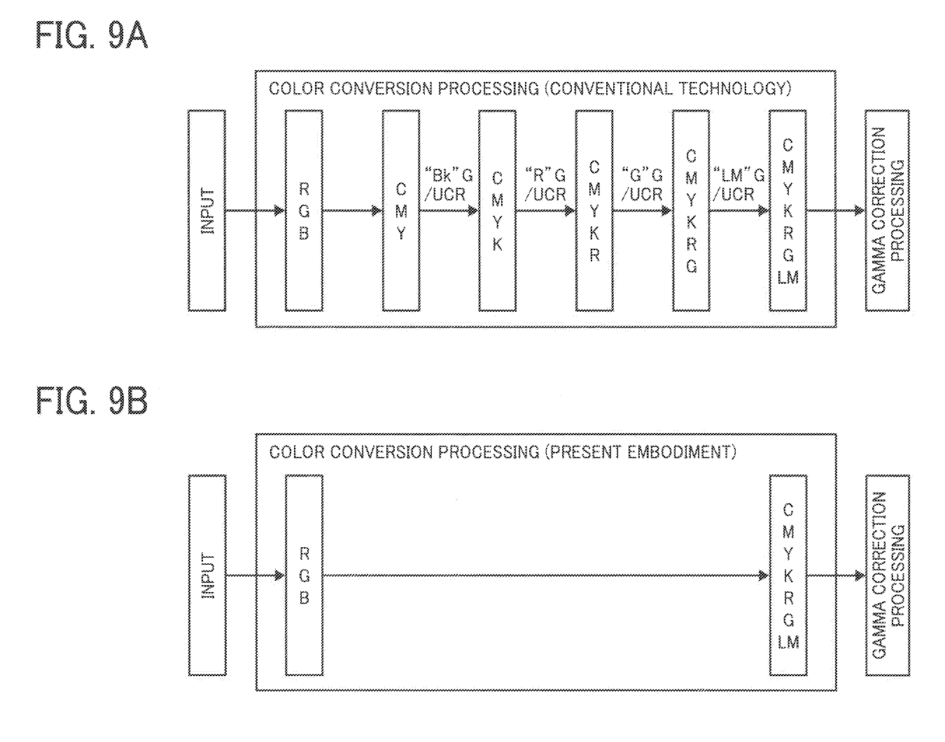

Given below is the description about the color conversion processing performed by the color conversion unit 121 according to the present embodiment in comparison with the color conversion processing in the conventional technology. FIGS. 9A and 9B are explanatory drawings for explaining the differences in the color conversion processing performed by the color conversion unit 121 according to the present embodiment and the color conversion processing in the conventional technology. FIG. 9A represents the color conversion processing in the conventional technology and FIG. 9B represents the color conversion processing according to the present embodiment.

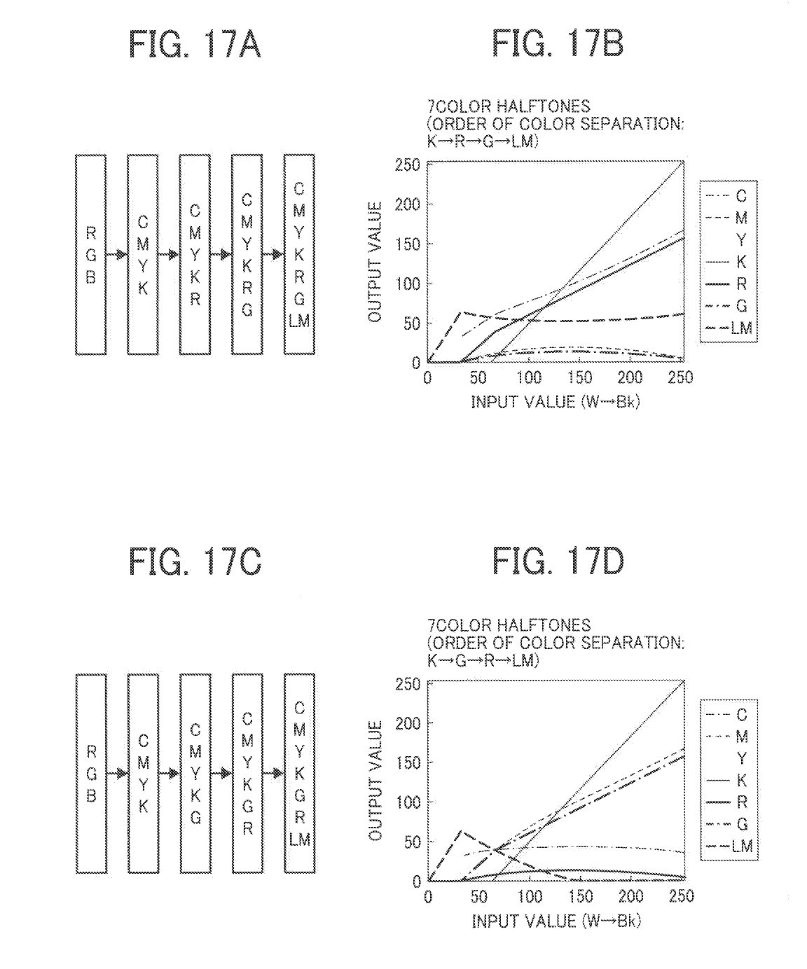

As illustrated in FIG. 9A representing the conventional technology, color conversion is performed in the order of RGB-to-CMY conversion, CMY-to-CMYK conversion, CMYK-to-CMYKR conversion, CMYKR-to-CMYKRG conversion, and CMYKRG-to-CMYKRGLM conversion. That is, the color data of supplementary colors except C, M, Y, and K is generated based on the CMYK data. Thus, as described above with reference to FIGS. 17A to 17D, depending on the order of color separation, there occurs deterioration in the image quality in the form of a bias in the amount of ink generation and aberration in colors. Moreover, since the color separation processing is performed in sequential manner in the conventional technology, the amount of calculations increases and the processing speed becomes slow.

In contrast, in FIG. 9B representing the color conversion processing according to the present embodiment, for example, RGB data is directly converted into CMYKRGLM data with the use of the color conversion table. That is, in the present embodiment, the CMYK data as well as the color data of supplementary colors expect C, M, Y, and K is directly converted into the output data without generating the intermediate data. By performing direct color conversion, it becomes possible to eliminate the problem of bias in the amount of ink generation that can occur depending on the order of color separation. Because of that, it becomes possible to overcome the problem in which the difference in the amount of ink usage causes aberration in colors and the problem in which a bias occurs in the consumption/replacement of ink cartridges. Moreover, since the color separation processing is performed collectively, the amount of calculations is small and the processing can be speeded up.

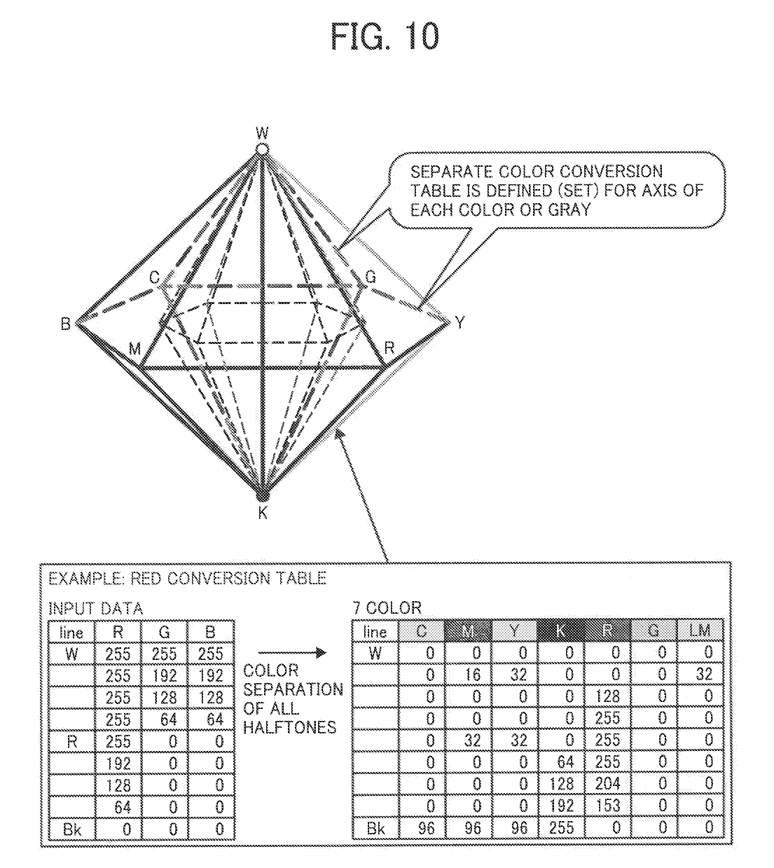

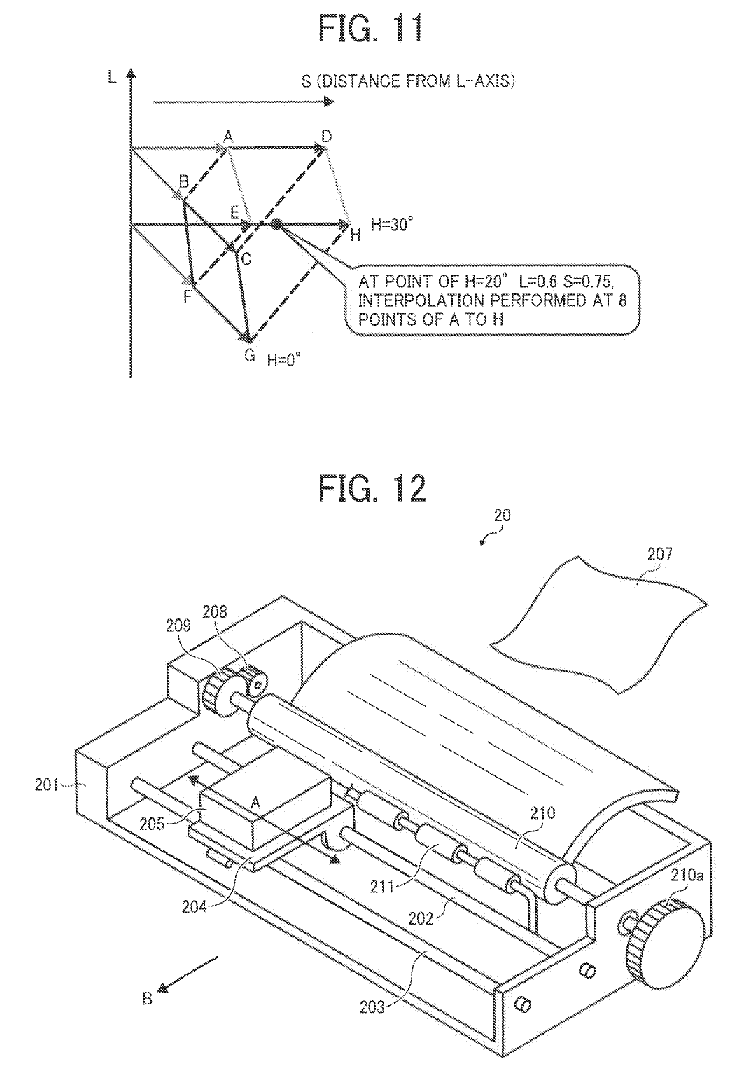

Given below is the description with reference to FIGS. 10 and 11 about the methods of generating the color conversion table according to the present embodiment. Firstly, as the design principle of the color conversion table, when any one of R, G, and B is at maximum (for 8 bit, 255) or at minimum (for 8 bit, 0) except for white (for 8 bit, R=G=B=255) and black (for 8 bit, R=G=B=0); then the number of combinable colors is set to the requisite minimum number.

Herein, the requisite minimum number is the minimum number of necessary color materials that need to be combined in order to express the target color. For example, in a printing apparatus compatible to CMYKR, only the R ink is used to express the highlighted side of the red hue (white to 255 gradations of red) and the R+K ink is used to express the shadowed side of the red hue (255 gradations of red to black). Moreover, in order to express the orange color between the red hue and the yellow hue, only the R+Y ink is used to express the highlighted side of the orange hue (white to 255 gradations of orange) and the R+Y+K ink is used to express the shadowed side of the orange hue (255 gradations of orange to black). In this way, by minimizing the number of color materials to be used, it becomes possible to minimize the ink usage. That in turn enables prevention of defects such as cockling (swelling of paper due to ink absorption), beading (roughness due to adhesion of droplets), or bleeding (blurring of color boundaries) in an image. Moreover, with a decrease in the ink usage, it becomes possible to reduce the frequency of replacing the ink cartridges and to use the printing apparatus at low cost.

FIG. 10 is an explanatory diagram for explaining the case when the color conversion table is designed for each color hue according to the abovementioned design principle. The color hues mentioned herein represent color hues of the ink colors filled in the printing apparatus. With reference to FIG. 11, a method of creating a color conversion table that includes all colors in the input image data including the other colors is described in which interpolation calculation is performed on the color conversion table designed in FIG. 10. In FIG. 11, interpolation calculation is performed after converting the RGB color space of the input image data into the HLS color space. However, alternatively, interpolation calculation can also be performed with respect to RGB color space or with respect to another color space such as HSB color space. The color conversion table can be configured as described in the following points (1) to (9).

(1) When the input image has R=G=B, then only K is output as the conversion result. Because of that, even in a configuration using C, M, Y, K, as well as supplementary colors, it becomes possible to reproduce a gray balance with no color fading (wrong color, or changing to other color).
(2) When the input image has R=G=B, then all ink colors used in printing by the printer are output as the conversion result. Because of that, even in a configuration in which a nozzle is disposed for each of C, M, Y, K, and supplementary colors, it becomes possible to prevent drying the nozzles. That enables providing a high-throughput printer that does not need frequent maintenance.
(3) When each of R, G, and B of the input image is other than the maximum or the minimum, then the output is performed with all colors used in the recording apparatus. That also helps in preventing drying of the nozzles and providing a high-throughput printer that does not need frequent maintenance.
(4) Depending on the luminance or density at the time of output, the ink usage configuration can be changed or all ink colors can be output. For example, in the CIELAB D50-2° environment, if the luminance (L*) is equal to or smaller than 60 or the K-component density is equal to or greater than 0.55, then all ink colors can be used. Within that region, in a region expressed by the primary color or the secondary color of a color ink, the discharge of a very small amount of ink including complementary components or K remains inconspicuous on the image. Thus, by outputting all colors used in the recording apparatus, it becomes possible to prevent the nozzles from drying and provide a high-throughput printer that does not need frequent maintenance.
(5) In an ink of five colors or more, it is possible to include colors that can be expressed by a combination of any of the two colors from among C, M, Y, and K. The examples of such colors are R (combination of M and Y), G (combination of C and Y), and B (combination of C and M). That enables expansion of the color gamut (see FIG. 5).
(6) In an ink of five colors or more, it is possible to include any one of C, M, Y, and K that is set to low density or high luminance, that is, include a color such as LC (lightened C, or color obtained by lightening C) or LM (obtained by lightening M). That enables enhancing the granularity/gradation of particularly the highlighted part (see FIG. 5).
(7) In an ink of five colors or more, it is possible to include any one of C, M, Y, and K that is set to high density or low luminance, that is, include a color such as DY (obtained by heightening Y) or DM (obtained by heightening M). That enables enhancing the granularity/gradation of particularly the shadowed part (see FIG. 5).
(8) It is also possible to include the white color in an ink of five colors or more. That enables enhancing the degree of whiteness of the paper and expanding the dynamic range (luminance difference in image) (see FIG. 7).
(9) It is also possible to include a metallic color such as the golden color or the silver color in an ink of five colors or more. Consequently, it becomes possible to express a color having a metallic gloss (see FIG. 6). To express a metallic color, following methods can be implemented.

As the first example, the golden color can be used when certain data is included in the RGB values. For example, when the RGB values include the value indicating the golden color (RGB=(255, 204, 0) in Microsoft Windows (registered trademark) or RGB=(255, 215, 0) in the web colors used over Internet), it is possible to use the gold grain or the metallic grain of brass that is close to the golden color. Similarly, when the RGB values include the value indicating the silver color (RGB=(192, 192, 192) in the web colors used over Internet), it is possible to use the silver grain or the metallic grain of aluminum that is close to the silver color.

As the second example, the metallic color portion can be detected by analyzing the histogram of the image data. For example, if the image data includes a portion indicating metal utensils, then that portion can be detected and the metallic color can be output using a color conversion table made exclusively for such a portion. By implementing such methods, it becomes possible to express metallic colors having glossiness that cannot be expressed using normal pigments or dyes.

As described above, according to the first embodiment, the color conversion unit 121 makes use of the color conversion table 124 and converts the input image data directly into output image data that is expressed in the color material of five colors or more. That makes it possible to eliminate the bias in the ink usage that can occur depending on the color separation and prevent aberration in colors. Moreover, it is possible to prevent the bias in the consumption/replacement of ink cartridges. Furthermore, since the color separation processing can be performed collectively, the amount of calculations is small and the processing can be speeded up.

Besides, according to the first embodiment, by minimizing the number of color materials it becomes possible to reduce the ink usage so that defects such as cockling, beading, or bleeding can be prevented from occurring and the amount of ink consumption can be held down.

Moreover, when the input image has R=G=B, then all ink colors used in printing by the printer are output as the conversion result in the first embodiment. Because of that, even in a configuration in which a nozzle is disposed for each of C, M, Y, K, and supplementary colors; it becomes possible to prevent drying of the nozzles. That enables providing a high-throughput printer that does not need frequent maintenance.

Furthermore, according to the first embodiment, since color conversion and density correction can be performed at the same time; the number of steps in the image processing operation decreases and the processing speed increases.

Moreover, according to the first embodiment, the amount of ink usage can be changed depending on the luminance or density. Preferably, in a region having the luminance equal to or smaller than 60 or having the K-component density equal to or greater than 0.55, all ink colors used in a printer can be output. Because of that, even in a configuration in which a nozzle is disposed for each of C, M, Y, K, and supplementary colors, it becomes possible to prevent drying of the nozzles. That enables providing a high-throughput printer that does not need frequent maintenance.

Furthermore, according to the first embodiment, when each of R, G, and B of the input image is other than the maximum or the minimum; the output is performed with all colors used in the recording apparatus. That also helps in preventing drying of the nozzles and providing a high-throughput printer that does not need frequent maintenance.

Moreover, according to the first embodiment, by including colors that can be expressed by combining any of the two colors among C, M, Y, and K, that is, by including R (combination of M and Y), G (combination of C and Y), and B (combination of C and M) in an ink of five colors or more; it becomes possible to expand the color gamut.

Furthermore, according to the first embodiment, by including any one of C, M, Y, and K in a lightened state, that is, by including LC (obtained by lightening C) or LM (obtained by lightening M) in an ink of five colors or more; it becomes possible to enhance the granularity/gradation.

Moreover, according to the first embodiment, by including any one of C, M, Y, and K in a heightened state, that is, by including DY (obtained by heightening Y) or DM (obtained by heightening M) in an ink of five colors or more; it becomes possible to enhance the granularity/gradation.

Furthermore, according to the first embodiment, by including the white color in an ink of five colors or more, it becomes possible to enhance the degree of whiteness of the paper and to expand the color gamut.

Moreover, according to the first embodiment, when the input image has R=G=B; then only K is output as the conversion result. Because of that, even in a configuration using C, M, Y, K, as well as supplementary colors; it becomes possible to reproduce a gray balance with no color fading, wrong color, or changing to other color.

Furthermore, according to the first embodiment, by including a metallic color such as the golden color or the silver color in an ink of five colors or more, it becomes possible to express a color having a metallic gloss.

[Recording Apparatus]

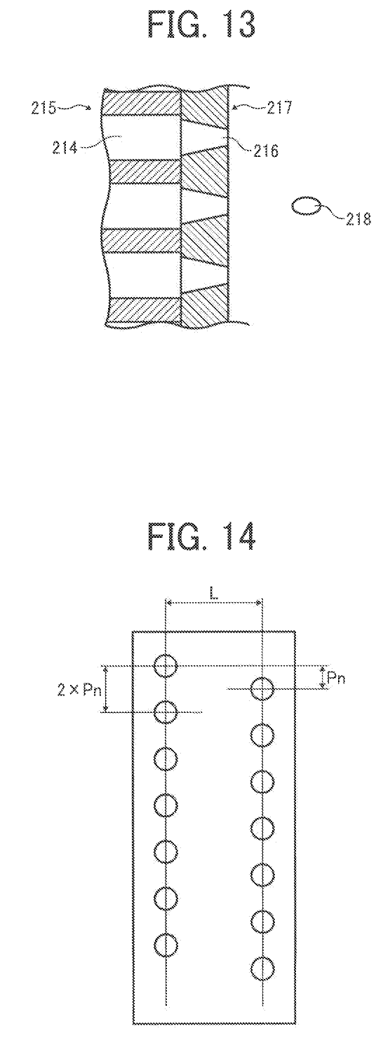

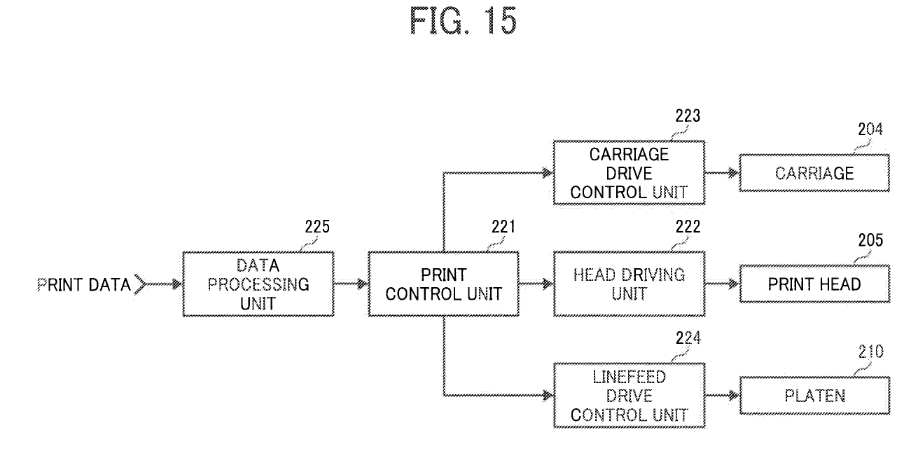

Given below is the description of a specific configuration of the printer 20 illustrated in FIG. 1. In the present embodiment, the printer 20 is configured to be an inkjet recording apparatus of the serial inkjet type. Regarding this inkjet recording apparatus, an exemplary case of using an ink (color material) of six colors of C, M, Y, K, R, and G is described. FIG. 12 is a schematic perspective view of the mechanical portion of the inkjet recording apparatus. FIG. 13 is a cross-sectional diagram of the essential portion of an inkjet head in the inkjet recording apparatus illustrated in FIG. 12. FIG. 14 is an explanatory diagram of nozzles in the inkjet head illustrated in FIG. 12. FIG. 15 is a block diagram of essential constituent elements of a control unit for the configuration in FIG. 12.

As illustrated in FIG. 12, in the inkjet recording apparatus according to the present embodiment, guide rails 202 and 203 are laid across laterally on a frame 201. A carriage 204 is moveably mounted on the guide rails 202 and 203, and has a print head 205 mounted thereon. A driving source (not illustrated) such as a motor is used to move the carriage 204 in the direction of an arrow A. A paper sheet 207, which is the target medium for printing, is set on a guide plate and is fed to a platen 210. The platen 210 includes a knob 210a that is rotated by a driving source (not illustrated) via a drive gear 208 and a sprocket gear 209. The paper sheet 207 is conveyed in the direction of an arrow B between the peripheral surface of the platen 210 and a pressure roller 211 that is pressure-welded thereto.

In the inkjet recording apparatus, the print head 205 (carriage 204) is moved in the main-scanning direction (direction of arrow A) and the paper sheet is moved in the sub-scanning direction (direction of arrow B). At that time, ink droplets are sprayed from the print head 205 so that an image is printed on the paper sheet 207.

The detailed explanation of the carriage 204, the print head 205, and an ink supplying system is given below. The carriage 204 includes the print head 205 that is an inkjet head for discharging ink droplets of cyan (C), magenta (M), yellow (Y), black (Bk), red (R), and green (G) colors. The print head 205 has a plurality of ink discharging openings that are arranged in an intersecting manner with the main-scanning direction so that the ink droplets are discharged in the downward direction. Moreover, the carriage 204 also includes a plurality of ink cartridges (not illustrated) that are replacably disposed and that supply ink colors to the print head 205.

On the upper side of each ink cartridge is disposed an air duct that is in communication with air and on the lower side of each ink cartridge is disposed a supply outlet that supplies an ink to the inkjet head. Inside the ink cartridge is present a porous body filled with the ink. Due to the capillary force of the porous body, the ink to be supplied to the inkjet head is maintained at a slightly negative pressure.

In the present example, the print head 205 is configured to include a separate head configuration for each color. However, it is also possible to configure the print head 205 as a single head configuration in which a nozzle row is arranged for discharging the ink of all colors. Moreover, as the print head (inkjet head) 205 that forms ink droplets by applying pressure on the ink, it is possible to use a piezoelectric-type inkjet head in which the wall surface of the ink room is made of electromechanical transduction elements such as piezoelectric elements and the pressure is applied on the ink with a vibrating plate. Alternatively, it is also possible to use an electrostatic-type inkjet head in which an electrostatic force between a vibrating plate, which forms the wall surface of the ink flow passage, and an electrode, which is disposed opposite to the vibrating plate, is used to vibrate the vibrating plate so that pressure is applied to the ink. In the present embodiment, the explanation is given for the piezoelectric-type inkjet head.

As illustrated in FIGS. 13 and 14, in the print head 205, a nozzle plate 217 having a plurality of nozzles 216 formed thereon is disposed in front of ink room forming members (ink room) 215 that form respective ink rooms 214. Pressure is applied to the ink inside each ink room 215 with an actuator (not illustrated) that is an energy generating unit using piezoelectric elements. As a result, the ink inside that ink room 215 gets discharged in the form of an ink drop 218 from the corresponding nozzles 216 on the nozzle plate 217. The discharged ink then gets attached to the paper sheet 207 as an ink dot. At that time, by selectively driving the actuators, which apply pressure to the ink rooms 214, an intended image can be printed on the paper sheet 207.

In the print head 205, the plurality of nozzles 216 form a plurality of ink-dot forming units. The row of nozzles 216 (nozzle row) is arranged perpendicular to the main-scanning direction and the inter-nozzle pitch between the nozzles 216 is 2×Pn. Moreover, in a single head, two nozzle rows are arranged with a distance L provided therebetween. The two nozzle rows are arranged out of alignment by Pn and in a cross stitch pattern along the sub-scanning direction. By using the two nozzle rows, an image of pitch Pn can be formed by performing the main-scanning and sub-scanning only once.

Herein, the inkjet recording apparatus according to the present embodiment is assumed to not have a dot pattern generating function that is used in performing actual recording inside the apparatus upon reception of an image drawing instruction or a character printing instruction. That is, a printing instruction issued from an application software, which is being executed in a host computer (e.g., PC), is processed and rasterized into dot pattern data in a print driver that is installed as a software component in the host computer. The dot pattern data is then transferred to the inkjet recording apparatus for printing.

More particularly, an image drawing instruction or a character recording instruction (e.g., instruction regarding position, thickness, and shape of lines to be recorded or regarding font, size, and position of characters to be recorded) issued from an application inside the host computer or from the operating system (OS) of the host computer is temporarily stored in a drawing data memory (not illustrated). Meanwhile, such instructions are written in a specific print language. An instruction stored in the drawing data memory is interpreted by a rasterizer and, if the instruction is a line recording instruction, the instruction is converted into print dot data according to the specified position or thickness and stored in a raster data memory (not illustrated). On the other hand, if the instruction is a character recording instruction, contour information of the corresponding characters is invoked from font outline data stored in the host computer, converted into print dot data according to the specified position or thickness, and stored in the raster data memory. At that time, the host computer rasterizes, into the print dot data, a typical orthogonal grid as a basic recording position. The print dot data stored in the raster data memory is then transferred to the inkjet recording apparatus via an interface.

As illustrated in FIG. 15, the control unit of the inkjet recording apparatus illustrated in FIG. 12 includes a print control unit 221, a head driving unit 222 that drives the actuators of the print head 205, a carriage drive control unit 223 that drive-controls the carriage 204, a linefeed drive control unit 224 that rotary-drives the platen 210, and a data processing unit 225.

The print dot data transferred from the PC 10 is stored in the raster data memory. The data processing unit 225 performs predetermined processing on the print dot data stored in the raster data memory and outputs the processed data to the print control unit 221. Based on the processed print dot data received from the data processing unit 225, the print control unit 221 instructs the head driving unit 222 to discharge (spray) ink drops from predetermined nozzles from among the nozzles 216 in the print head and record an image, which corresponds to the print dot data, on the paper sheet 207. Moreover, the print control unit 221 instructs the carriage drive control unit 223 to move (main-scanning) the carriage 204 and instructs the linefeed drive control unit 224 to rotate the platen 210, that is, to convey (sub-scanning) the paper sheet 207.

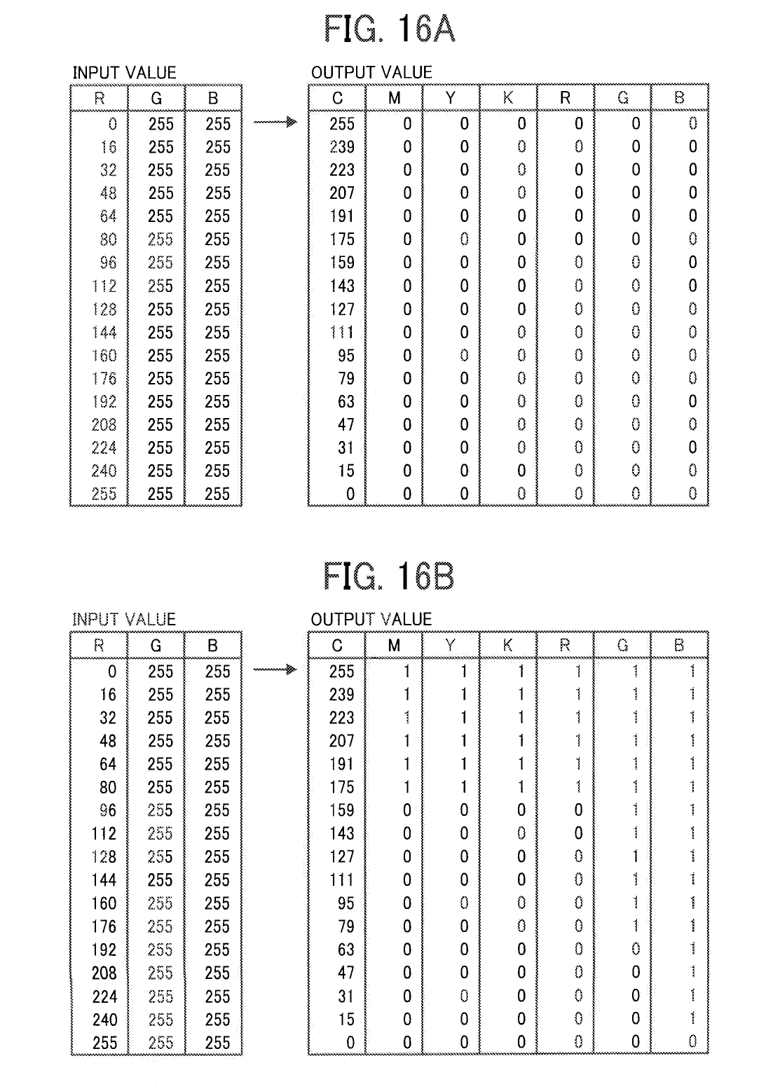

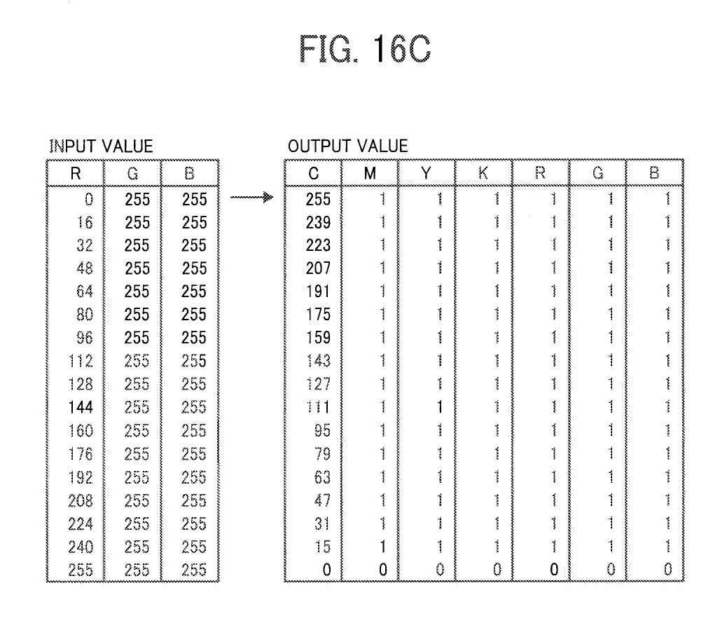

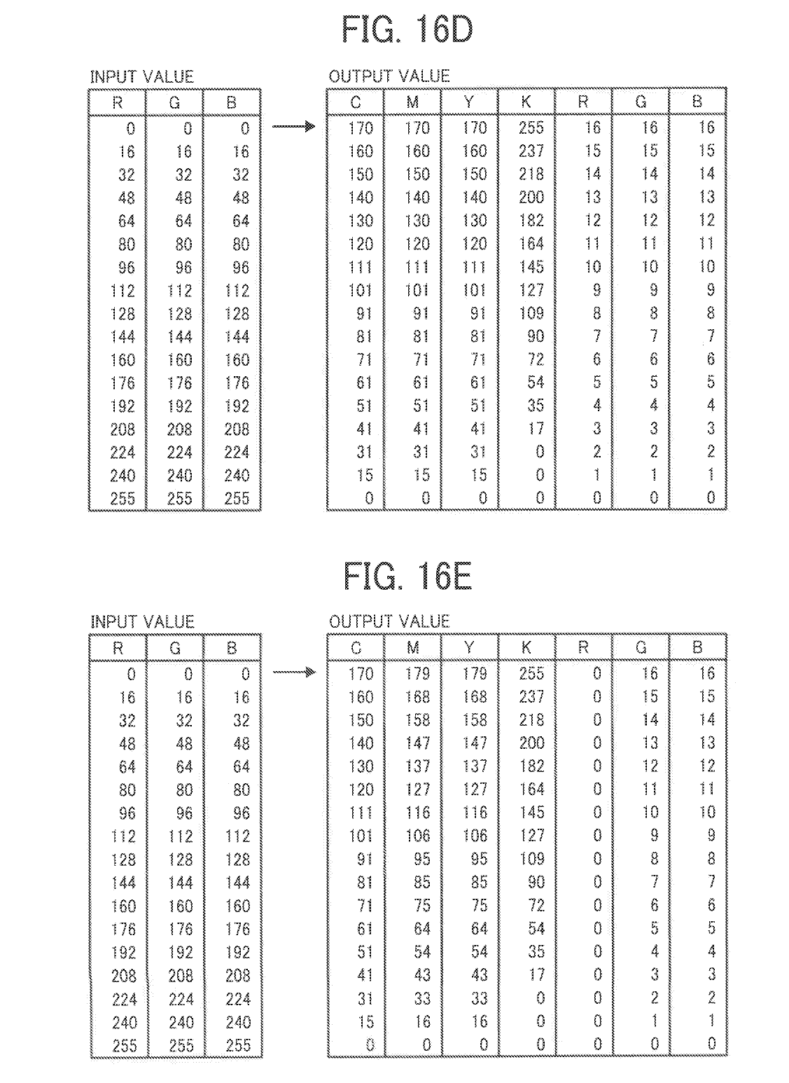

Given below is the description of the color conversion unit 121 and the color conversion table 124 according to a second embodiment of the present invention. In the second embodiment, the configuration of the image processing system 1, the image processing unit 12, and the recording apparatus is identical to that described in the first embodiment. Hence, that description is not repeated and only the differences are explained below. FIGS. 16A to 16E are explanatory diagrams of configuration examples of the color conversion table 124.

(1) In the color conversion table 124, the number of color materials to be used is minimized so that it becomes possible to minimize the ink usage and enables achieving low-cost printing. However, simply minimizing the number of inks means that a smaller number of nozzles are used. That can lead to the drying of unused nozzles and cause malfunctioning while discharging the inks. For example, as illustrated in the example in FIG. 16A, using only those nozzles which discharge a single color (cyan) can sometime lead to the drying of the unused nozzles for other colors.

In regard to that problem, in the second embodiment, an infinitesimal amount of the ink of at least one color other than the requisite minimum colors is discharged so that it becomes possible to prevent nozzle drying and in turn prevent defects in ink discharging. That is, in the second embodiment, in the case of converting the input image data directly into the output image data; the color conversion table 124 is configured in such a way that, for a requisite minimum number of color materials equal to N, the target color is expressed with N+1 color materials or more. In the example illustrated in FIGS. 16B and 16C, apart from discharging the ink of C as the requisite minimum color, an infinitesimal amount of ink of M, Y, K, R, G, and B is also discharged.

In this way, by not setting the number of color materials as the requisite minimum number and by discharging an infinitesimal amount of the other colors, it becomes possible to prevent defects in ink discharging and, regarding defects in the output image, prevent cockling (swelling of paper due to ink absorption), beading (roughness due to adhesion of droplets), or bleeding (blurring of color boundaries).

(2) In the explanation in point (2) regarding the color conversion unit according to the first embodiment, it is given that when the input image is RGB data having R=G=B, then all ink colors used in printing by the printer 20 are output as the conversion result. Although such a configuration is definitely desirable from the perspective of not having unused nozzles as far as possible, using all colors results in an increase in the ink usage and is disadvantageous from the cost perspective. For example, in the example illustrated in FIG. 16D, a large amount of the ink of C, M, Y, and K is used, while a small amount of the ink of R, G, and B is used.

In regard to that problem, by not using at least one of the ink colors filled in the printer 20, it becomes possible to prevent nozzle drying even while holding down the amount of ink consumption. That is, when the input image is RGB data having R=G=B and when the total number of color materials used in the printer 20 is P, then the color conversion table 124 is configured in such a way that the input image data is converted into output image data that can be expressed with the number of color materials equal to P−1. For example, in the example illustrated in FIG. 16E, a large amount of the ink of C, M, Y, and K is used and a small amount of the ink of G and B is used, while the ink of R is not used.

More particularly, in a high color-saturation region, it is preferable to not use one color among the complementary components. Meanwhile, to achieve the same effect, a plurality of color conversion tables that enable achieving an identical gray reproduction with different ink configurations can be set and a different color conversion table can be used corresponding to each image or each scan.

As described above, according to the second embodiment, when the color conversion unit 121 makes use of the color conversion table 124 and converts the input image data directly into output image data that is expressed in the color material of five colors or more and when the requisite minimum number of color materials is N; then the target color is expressed with N+1 color materials or more. That makes it possible to prevent nozzle drying and defects in ink discharging, and, regarding defects in the output image, prevent cockling (swelling of paper due to ink absorption), beading (roughness due to adhesion of droplets), or bleeding (blurring of color boundaries).

Moreover, according to the second embodiment, when the input image is RGB data having R=G=B; then the colors except at least one color used in printing by the printer are output as the conversion result. Because of that, even in a configuration in which a nozzle is disposed for each of C, M, Y, K, and supplementary colors, it becomes possible to prevent drying of the nozzles. That enables providing a high-throughput printer that does not need frequent maintenance.

Meanwhile, the abovementioned two embodiments can also be implemented in combination.

(Computer Program)

The color conversion apparatus according to the present invention can be applied to a system including a plurality of devices (e.g., host computer, interface device, scanner, and printer) or to an apparatus including a single device (e.g., host computer).

Meanwhile, the object of the present invention can also be achieved by providing, to a system or an apparatus, a recording medium, which is storing therein the program code of software that implements the functions of the abovementioned color conversion apparatus, and executing the program code, which is stored in the recording medium, in a computer (or a central processing unit (CPU), a micro processing unit (MPU), or a digital signal processor (DSP)) of the system or the apparatus. In that case, the program code read from the recording medium implements the functions of the abovementioned color conversion apparatus so that the recording medium storing therein the program code or the computer program constitutes the present invention. As a recording medium for providing the program code, it is possible to use a floppy disk (FD), a hard disk, an optical disk, a magneto-optical disk, a CD-ROM, a compact disk recordable (CD-R), a magnetic tape, a nonvolatile memory card, an optical recording medium such as a ROM, a magnetic recording medium, a magneto-optical recording medium, or a semiconductor-based recording medium.

The computer reads and executes the program code to perform the functions of the color conversion apparatus. That includes the case when the operating system running on the computer performs, in part or in whole, the functions of the color conversion apparatus.

The program code loaded from the recording medium can be written into a memory disposed in a function expansion board that is installed inside the computer or in a function expansion unit that is connected to the computer. In that case, a CPU in the function expansion board or the function expansion unit executes the instructions given in the program code and performs, in part or in whole, the functions of the color conversion apparatus.

Although the description in the present embodiment is given for an inkjet recording apparatus, the description is also applicable to a printer, a facsimileing apparatus, a copying apparatus, or a multifunction product (MFP) with printing, facsimileing, and copying functionality. Moreover, the abovementioned description is also applicable to an image forming apparatus using a recording liquid other than ink, or a data processing apparatus that provides print data to that image forming apparatus, or a printer driver installed in the data processing apparatus.

According to an aspect of the present invention, in order to perform color conversion on output image data to be output from a recording apparatus that uses a color material of five colors or more; a color conversion apparatus can be provided that enables elimination of the defects in the image that can occur depending on the order of color separation so that the image quality improves, enables prevention of bias in the amount of usage of the color material in the recording apparatus, and enables speeding up the color conversion processing.

According to another aspect of the present invention, in order to perform color conversion on output image data to be output from a recording apparatus that uses a color material of five colors or more; a color conversion apparatus can be provided that enables elimination of the defects in the image that can occur depending on the order of color separation so that the image quality improves, enables prevention of bias in the amount of usage of the color material in the recording apparatus, and enables speeding up of the color conversion processing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A color conversion apparatus for converting input image data into output image data that is to be output from a recording apparatus using a color material of five colors or more, the color conversion apparatus comprising:
a color conversion table that is used in performing color conversion of the input image data directly into the output image data; and
a color conversion unit that, by making use of the color conversion table, performs color conversion of the input image data directly into the output image data.

2. The color conversion apparatus according to claim 1, wherein
the color conversion table is configured so that a number of color materials used in expressing the output image data is at minimum.

3. The color conversion apparatus according to claim 1, wherein
the color conversion table is configured so that, when a minimum number of color materials used in expressing the output image data is assumed to be N, the output image data is expressed with number of color materials equal to N+1.

4. The color conversion apparatus according to claim 1, wherein
the color conversion table is configured so that, when the input image data is RGB data having R=G=B, or data value of R, G, and B equals each other, the input image data is converted into output image data with all color materials used in the recording apparatus.

5. The color conversion apparatus according to claim 1, wherein
the color conversion table is configured so that, when the input image data is RGB data having R=G=B, or data value of R, G, and B equals each other, and when number of all color materials used in the recording apparatus is assumed to be P, the input image data is converted into output image data with number of color materials equal to P−1.

6. The color conversion apparatus according to claim 1, wherein
the color conversion table is configured so that the color conversion and density correction are performed at a same time.

7. The color conversion apparatus according to claim 1, wherein
the color conversion table is configured so that number of color materials expressing the output image data is changed depending on luminance or density.

8. The color conversion apparatus according to claim 7, wherein
the color material of five colors or more includes K, or black color, and
for each of other colors except K among the five colors or more, the color conversion table expresses shadowed-side color with one of the other colors and K.

9. The color conversion apparatus according to claim 8, wherein
the color conversion table is configured so that, depending on luminance or density, the input image data is converted into output image data with all color materials used in the recording apparatus.

10. The color conversion apparatus according to claim 9, wherein
the color conversion table is configured so that, when, in a CIELAB D50-2° environment, luminance (L*) is equal to or smaller than 60 or K-component density is equal to or greater than 0.55, the input image data is converted into output image data with all color materials used in the recording apparatus.

11. The color conversion apparatus according to claim 1, wherein
the color conversion table is configured so that, when the input image data is RGB data and when each data value of R, G, and B is other than maximum or minimum, the input image data is converted into output image data with all color materials used in the recording apparatus.

12. The color conversion apparatus according to claim 1, wherein
the color material of five colors or more includes C, M, Y, K, and a color expressible by combination of any of two colors from among C, M, Y, and K.

13. The color conversion apparatus according to claim 1, wherein
the color material of five colors or more includes C, M, Y, K, and either one of C, M, Y, and K being changed to have low density or high density.

14. The color conversion apparatus according to claim 1, wherein
the color material of five colors or more includes C, M, Y, K, and white color.

15. The color conversion apparatus according to claim 1, wherein
the color conversion table is configured so that, when the input image data is RGB data having R=G=B, or data value of R, G, and B equal each other, the input image data is converted into output image data with only K.

16. The color conversion apparatus according to claim 1, wherein
the color material of five colors or more includes a metallic color.

17. The color conversion apparatus according to claim 16, wherein
the color conversion table is configured so that the input image data is substituted with a metallic color depending on the input image data.

18. The color conversion apparatus according to claim 17, wherein
the color conversion apparatus detects a metallic portion out of the input image data and substitutes a metallic color for the metallic portion by making use of the color conversion table.

19. A computer-readable recording medium that stores therein a computer program that causes a computer to implement a color conversion method for converting input image data into output image data that is to be output from a recording apparatus using a color material of five colors or more, the computer program causing the computer to execute:
reading a color conversion table that is used in performing color conversion of the input image data directly into the output image data; and
performing color conversion of the input image data directly into the output image data by making use of the color conversion table.

20. A color conversion method for converting input image data into output image data that is to be output from a recording apparatus using a color material of five colors or more, the color conversion method comprising
converting the input image data directly into the output image data by making use of a color conversion table that is used to convert the input image data directly into the output image data.
